(19) United States
(12) Patent Application Publication
(10) Pub. No.: US 2014/0081684 A1
(43) Pub. Date: Mar. 20, 2014

(54) SYSTEM AND METHOD FOR PROACTIVE OPTIMIZATION OF SELF-ACTIVATED SERVICES

(71) Applicant: CA, INC., Islandia, NY (US)

(72) Inventor: Eitan HADAR, Nesher (IL)

(73) Assignee: CA, INC., Islandia, NY (US)

(21) Appl. No.: 13/623,721

(22) Filed: Sep. 20, 2012

(51) Int. Cl. G06Q 10/00

(52) U.S. Cl. 705/7.12; 705/7.41

(57) ABSTRACT

A method includes monitoring a service provided to a consumer to determine an actual quality attribute of the service provided to the consumer. The method further includes comparing a potential quality attribute of an alternative service with the actual quality attribute of the service provided to the consumer to determine a difference between the potential quality attribute and the actual quality attribute. In addition, the method includes comparing the difference between the potential quality attribute and the actual quality attribute with a potential action preference of the consumer. The method also includes performing an action according to the potential action preference in response to determining that the difference between the potential quality attribute and the actual quality attribute satisfies a specific criterion defined in the potential action preference.

### BACKGROUND

The present disclosure relates to information technology service management and, more specifically, to a system and method for proactive optimization of self-activated services.

Existing information technology service management systems manage service catalogs that offer a centralized location for self-service activation for the organization. In addition, existing tools assist in the creation of relevant reports, based on information maintained in a data store. Such existing reporting tools assist in understanding service activation patterns, which include quality information, duration information, and usage information. These data-stores offer analytics capability (i.e., business intelligence), which indicate what services and features have been used and, based on simplified event correlations and business rules, what services and features may be used in the future. In some sophisticated cases, consumers register for particular events in order to evaluate certain service patterns.

### BRIEF SUMMARY

According to one aspect of the present disclosure, a method may comprise monitoring a service provided to a consumer to determine an actual quality attribute of the service provided to the consumer. The method further may comprise comparing a potential quality attribute of an alternative service with the actual quality attribute of the service provided to the consumer to determine a difference between the potential quality attribute and the actual quality attribute. In addition, the method may comprise analyzing the difference between the potential quality attribute and the actual quality attribute utilizing a potential action preference of the consumer. The method also may comprise performing an action according to the potential action preference in response to determining that the difference between the potential quality attribute and the actual quality attribute satisfies a specific criterion defined in the potential action preference.

Other objects, features, and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 is a schematic representation of a network for service providers and consumers of provided services.

FIG. 2 is a schematic representation of a system configured to activate and proactively optimize services provided to a consumer.

FIG. 3 illustrates a process of proactively optimizing self-activated services according to particular embodiments of the disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component.” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

Referring now to information technology service management systems, existing systems may focus on reporting capabilities, rather than proactive optimization (e.g., constant improved change towards a defined goal) driven by the systems. Systems and methods disclosed herein may utilize optimization, which may be linked to overall Service Metric Indications (“SMI”), as configured by CA Technologies (e.g., QUARCS), or which may be linked to aggregated and compound metrics that may be part of monitored service levels.

Within the context of, for example, a service catalog or a service arena, modules described herein may present systems and methods for self-activated service requestors and service providers to proactively optimize service engagements using, for example, a combination of automation and contractual agreements. Such systems and methods may proactively optimize service engagements based on, for example, an (1) understanding of what service was activated for contractual or financial reasoning and auditing; the (2) ease of reuse and re-activation of the service; an (3) objective to drive additional consumptions while increasing an overall quality of the service; and an (4) objective to drive service change through, for example, improvement or replacement, according to proactive recommendations provided by such systems and methods.

Systems and methods disclosed herein may record the actual activation parameters of a service, which may comprise a definition of what service is used (e.g., schema for self-service activation), an identification of who activated the service and when the service was activated (e.g., transient schema for contracted service), and information regarding the requested reporting features (e.g., schema for self-service reporting).

Such systems and methods disclosed herein may provide consumers with the ability to monitor changes and to be informed of variations (e.g., in case of an-on going service, such as provisioning a server, a variation such as a high-availability of 99.99% over the next month). In addition, such systems and methods may report on the success and failure of a single process, or such systems and methods may provide for statistical activation or deactivation (, in case of a short, run-to-complete service, removing user access from a system).

Such systems and methods disclosed herein may offer consumers, according to demand, some or all of the historical activated actions, a level of quality for specific users, and information about how the service has performed recently (g, whether the quality has improved or degraded since the consumer last used the service). Such information about how the service has performed recently may be based on a history of the self-service for a particular user compared with statistical information based on history of the self-service for some or all of the users employing the same service. Quality may be defined as the overall SMI of aggregated metrics that interest the user, which may comprise, for example, financial implications (e.g., cost).

While the user is consuming existing services, such systems and methods disclosed herein may notify the consumers of alternative services (cg, other services from a service catalogue or service arena monitored by the systems disclosed herein or monitored utilizing methods disclosed herein) that provide the same or similar services, and such systems and methods may offer a proactive change to one or more of the alternative services. This proactive suggestion may be made during a real activation of a service (e.g., activation for implementation), rather than in a preliminary stage prior to activation (e.g., during design).

Such systems and methods disclosed herein may enable the user to establish one or more of automatic service changes and automatic changes of a service provider, according to a preconfigured optimization policy, while adhering to corporate policies. Such changes may be targeted for one or more of the initial design of a service, the deployment of a service, and the selection of a service, which may be relevant for “run-to-complete” services, rather than for ongoing services (e.g., servers that were provisioned for a consumer). Because the self-service may imply that only the consumer may decide whether the change may occur, each of the change and conditional polices may be under the control of the consumer and may be subject to restrictions provided by vendors of available services. This approach may enable the creation of a flexible contract for the self-service, which may allow the actual implementation of the service to vary in such a manner that the service remains approved by the consumer. In the systems and methods disclosed herein, the rules may comprise rules driven by consumers (e.g., role-based polices), in addition to or in the alternative of one or more of enterprise information technology (“IT”) rules and managed service provider (“MSP”) rules. An example may comprise notifying an end-consumer about reduced prices or specific deals associated with re-activation of a previously-used service. Another example may comprise one or more of offering a service change to an activated service based on reduced quality levels or changes in price over time and recommending a change of service provider based on reduced quality levels or changes in price over time (e.g., downgrade a service to reduce costs, upgrade a service when cost decreases).

Such systems and methods disclosed herein may suggest constant optimization through changes and improvements and may automate implementation of such changes and improvements, such that consumer may not be burdened by accepting proposed changes and improvements or implementing such changes and improvements. Such systems and methods may utilize preferences (e.g., one or more optimization goals of a consumer), prioritized according to what is more important (e.g., prioritized using weighting factors), and may suggest alternatives that may be conducted automatically when in compliance with a user policy.

In the systems and methods disclosed herein, optimization policies may be driven by individual activators (e.g., a single individual), rather than being driven by service providers or by service brokers. As such, different end-users, within the same organization, that activate the same conceptual service may use one or more of different systems, different processes, and different services because the different end-users may establish different constraints. For example, some end-users may care more for cost, while other end-users may care more for availability. In an operation research domain, such concepts may be referred to as a feasibility search. More particularly, such concepts may be referred to as a feasibility search within a constrained, optimized environment.

Even more so, such systems and methods disclosed herein may provide notifications of improvements and other feedback to the end-user. Although the service may be self-activated, it may be important to provide visibility on the improvements made to the self-service systems that may focus on ease of activation and reduced complexity. Such systems and methods disclosed herein may increase quality over time, constantly delighting the customers by providing visibility of the optimizations that the end-user prefers.

In such self-service systems and methods, where a human operator may not be a part of the process, a gradual and constant increase in quality compared with competing services may be made apparent. Such self-service systems and methods may make the constant improvement apparent to the end-users, on a personal level, which may enable a perception of free choice and meaningful improvements according to self-preferences of the end-user. As such, the proactive optimizer (e.g., an optimizing device) may highlight improvements in activations and in quality of the self-services that the specific end-user may consume or consider activating e.g., personalization and optimization of self-service). In the domain of situational applications, even small tuning of existing services may change a user's ability and desire to use or not use a service. Self-preferences may be difficult to group into a one-size-fits-all grouping, and as such, the proactive optimizer may increase usability of services by supporting specific tuning of existing self-services based on specific consumers' preferences.

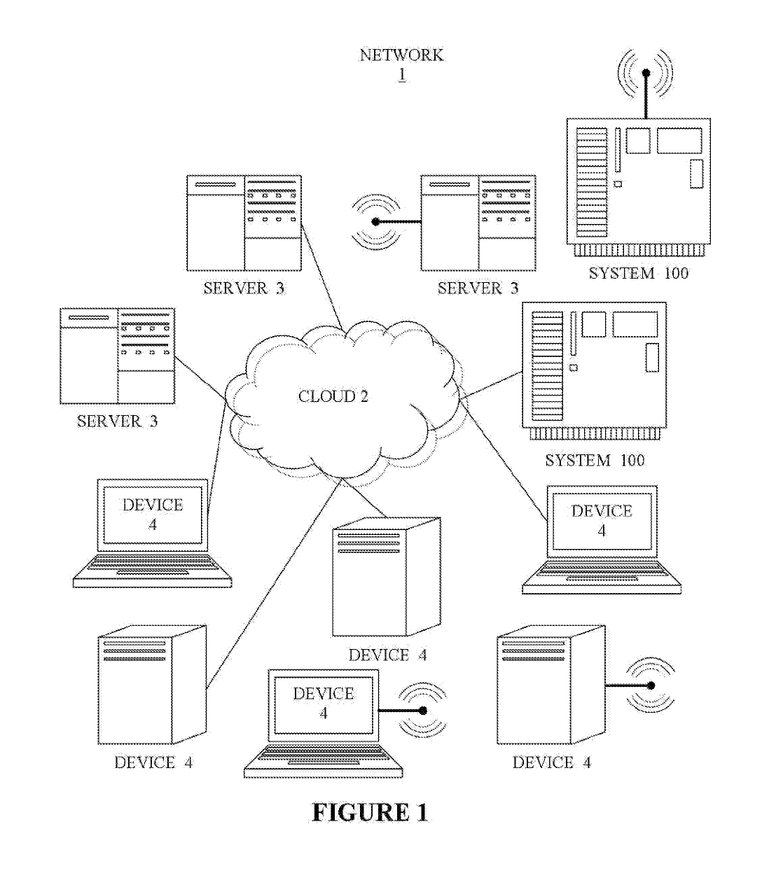

Referring now to FIG. 1, a network 1 for service providers and consumers of provided services now is described. Network 1 may comprise one or more clouds 2, which may be public clouds, private clouds, or community clouds. Each cloud 2 may permit the exchange of information and services between information providers, service providers, consumers of provided information, consumers of provided services, and brokers that are connected to such clouds 2. In certain configurations, cloud 2 may be a wide area network, such as the Internet. In some configurations, cloud 2 may be a local area network, such as an intranet. Further, cloud 2 may be a closed, private network in certain configurations, and cloud 2 may be an open network in other configurations. Cloud 2 may facilitate wired or wireless communications between information providers, service providers, consumers of provided information, consumers of provided services, and brokers.

Network 1 may comprise one or more servers 3 and other devices operated by one or more service providers. Network 1 also may comprise one or more devices 4 utilized by one or more consumers of provided services. The one or more service providers may provide services to the one or more consumers utilizing the one or more servers 3, which connect to the one or more devices 4 via cloud 2. The services may comprise, for example, information technology services, financial services, business services, access services, and other resource-provisioning services. Servers 3 may comprise, for example, one or more of general purpose computing devices, specialized computing devices, mainframe devices, wired devices, wireless devices, and other devices configured to provide services to consumers. Devices 4 may comprise, for example, one or more of general purpose computing devices, specialized computing devices, mobile devices, wired devices, wireless devices, passive devices, routers, switches, and other devices utilized by consumers of provided services.

Moreover, network 1 may comprise one or more system 100 that may monitor, activate, and proactively optimize services provided by the one or more service providers to the one or more consumers. System 100 may be, for example, one or more of a general purpose computing device, a specialized computing device, a wired device, a wireless device, and any other device configured to proactively optimize services provided by the one or more service providers to the one or more consumers. System 100 may connect to cloud 2 and monitor servers 3 and the services available from the one or more service providers. System 100 also may monitor devices 4 and the services provided to the one or more consumers of provided services via cloud 2. By monitoring the one or more service providers and the one or more consumers, system 100 may generate rich datasets regarding available services and consumption patterns, comprising lists of available services, quality information about the available services, and consumer preferences for certain services. System 100 may utilize these data sets to offer services provided by the one or more service providers to the one or more consumers based on the one or more consumers' needs and desires, and to activate such services for the consumers via the cloud. In this manner, system 100 may proactively optimize the services provided to the consumer.

In some configurations, one or more of a server 3 operated by a service provider and a device 4 operated by a consumer may comprise system 100. In other configurations, system 100 may be separate from servers 3 and devices 4. In certain configurations, system 100 may be operated by a party other than a service provider or a consumer of provided services.

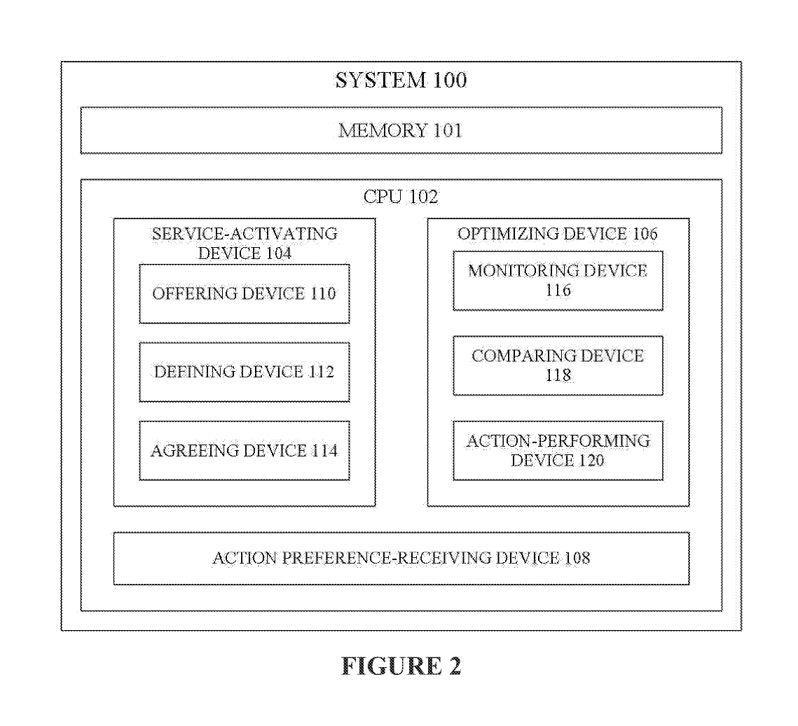

Referring now to FIG. 2, system 100 that may activate and proactively optimize services provided to a consumer now is described. System 100 may comprise a memory 101 and a central processing unit (“CPU”) 102. Memory 101 may store computer-readable instructions that may instruct system 100 to perform certain processes. In particular, when executed by CPU 102, the computer-readable instructions stored in memory 101 may instruct CPU 102 to operate as one or more of a service-activating device 104, an optimizing device 106 (e.g., the proactive optimizer), and an action preference-receiving device 108. More specifically, CPU 102 may operate as an offering device 110, a defining device 112, and an agreeing device 114 when the computer-readable instructions stored in memory 101 instruct CPU 102 to operate as service-activating device 104. In addition, CPU 102 may operate as a monitoring device 116, a comparing device 118, and an action-performing device 120 when the computer-readable instructions stored in memory 101 instruct CPU 102 to operate as optimizing device 106. In certain configurations, service-activating device 104 may comprise action preference-receiving device 108 (e.g., when a service provider and a consumer agree on certain potential action preferences while establishing a service agreement). In other configurations, optimizing device 106 may comprise action preference-receiving device 108 (e.g., when a service provider and a consumer do not agree on certain action preferences while establishing a service agreement or when a party other than the service provider controls optimizing device 106). In particular configurations, service-activating device 104 and optimizing device 106 may be implemented on different CPUs (e.g., a service provider operates service-activating device 104 and another party operates optimizing device 106).

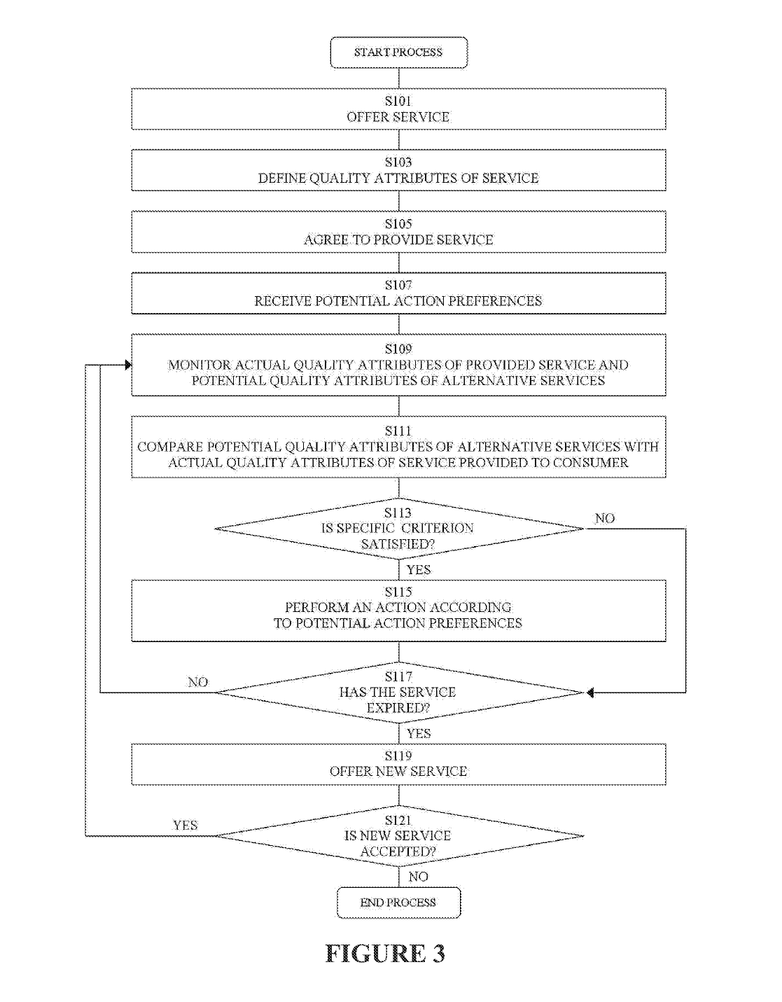

Referring now to FIG. 3, a method of proactively optimizing self-activated services performed by system 100 now is described. In S101, a service provider may offer a service to a consumer. The service may comprise, for example, one or more of data serving; network access; request management; self provisioning of a server, such as Amazon Elastic Compute Cloud™ (“Amazon EC2™”); self-archiving; and other IT services. The service provider may offer the service through offering device 110. In S103, one or more of the service provider and the consumer may define one or more quality attributes of the service to be provided. The one or more quality attributes may comprise, for example, one or more of a particular availability attribute that indicates an availability of the service over a given time period (e.g., a 99.99% availability over a one month period), a cost associated with the service (e.g., service costs, associated maintenance costs, facilities costs), a bandwidth of the service, a storage capacity associated with the service, a maintenance plan for the service, an attribute corresponding to risk (e.g., business, financial, safety, liabilities) associated with the service, an attribute associated with recovery options for the service when the service fails or other problems with the service occurs, an attribute associated with availability level of the service, an attribute associated with scalability of the service, an attribute associated with a load on the service, and other attributes that may be associated with the service. The one or more of the service provider and the consumer may use defining device 112 to define the quality attributes of the service. In S105, the service provider may agree to provide the service to the consumer in accordance with the one or more quality attributes defined in S103. This agreement may be referred to as a service level agreement (“SLA”). The service provider may use agreeing device 114 to agree to provide the service.

In S107, one or more of the service provider and another party (e.g., a broker, the consumer itself) may receive one or more potential action preferences of the consumer. The one or more of the service provider and the other party may receive the one or more potential action preferences from an optimization policy specified directly by the consumer. The optimization policy may comprise, for example, one or more of a preference for reducing cost while maintaining service quality, a preference for increasing availability of the service without incurring additional costs greater than a defined threshold cost, a preference for increasing bandwidth without incurring additional costs greater than a defined threshold cost, a preference for increasing storage space without incurring additional costs greater than a defined threshold cost, and a preference for decreasing costs without decreasing the value of other quality attributes below certain minimum levels. The one or more of the service provider and the other party may subject the optimization policy to certain restrictions, such as, for example, a limited selection of services, a limited range of bandwidth, and certain minimum costs. Thus, the consumer may specify the optimization policy in accordance with the certain restrictions. In certain configurations, the SLA also may comprise one or more of the optimization policy specified directly by the consumer and/or restricted by the service provider and other potential action preferences associated with the consumer. In certain configurations, the potential action preferences may comprise notification preferences (described below) specified by the consumer. In certain configurations, the potential action preferences may comprise preferences to automatically change (e.g., update) the current service when specific criteria are satisfied (described below). More generally, the potential action preferences define actions that the consumer desires the one or more of the service provider and the other party to activate, within restrictions established by the one or more of the service provider and the other party, based on, for example, one or more actual quality attributes of the service provided to the consumer, potential quality attributes of the alternative services (e.g., quality attributes defined in the SLA but not actually provided, quality attributes associated with upgrades, improvements, or other changes to the service). The one or more of the service provider and the other party may use action preference-receiving device 108 to receive the potential action preferences from the consumer.

Moreover, the potential action preferences may comprise one or more specific criterion to be satisfied before a particular action is activated. For example, a specific criterion may be that an actual quality attribute of the service provided to the consumer is less than some threshold, such as, for example, the value for a corresponding quality attribute defined in the SLA (e.g., the service is provided with at least a 95% availability). Thus, the specific criterion may be satisfied when the actual quality attribute of the service is determined to be an availability of 99%, but the criterion may not be satisfied when the actual quality attribute of the service is determined to be an availability of 90%. Accordingly, an example of a potential action preference defining both an action and a specific criterion may be an instruction for optimizing device 106 to automatically upgrade the service to increase availability when the actual availability of the service is less than the availability defined in the SLA. A consumer may place further restrictions on the potential action preference, such as, for example, only permitting optimizing device 106 to automatically upgrade the service when the cost of upgrading is less than or equal to a threshold cost. Another example of a potential action preference may be an instruction to automatically increase a bandwidth of the service when a number of activations of the service by the consumer exceeds a threshold number of activations and the cost of increasing the bandwidth is less than a predetermined threshold cost. The consumer may further define such a potential action preference to instruct optimizing device 106 to notify the consumer when the bandwidth is automatically increased according to the potential action preference or to instruct optimizing device 106 to request permission to increase the bandwidth of the service when the number of activations of the service exceeds the threshold number of activations but the cost of increasing the bandwidth is greater than the predetermined threshold cost.

Yet another example of a specific action preference may be an instruction for optimizing device 106 to automatically upgrade the service to increase an actual quality attribute when the current actual quality attribute of the service is less than a potential quality attribute of an alternative service (described below) by a threshold quantity or a threshold percentage difference. More specifically, for example, the specific action preference may be an instruction for optimizing device 106 to automatically upgrade the service to increase availability by at least 5% when the current actual availability of the service is less than a potential availability of an alternative service by at least 5%.

In some configurations, the potential action preferences may comprise instructions to change to an alternative service provided by a different service provider in addition to or in the alternative of changing or upgrading the current service when monitoring device 116 identifies an alternative service comprising quality attributes specified in the potential action preferences. The alternative service provided by the different service provider may be a modified instance of the service provided to the consumer or a new service. For example, such a potential action preference may be an instruction to automatically change to an alternative service comprising a greater bandwidth than the current service when a number of activations of the current service by the consumer exceeds a threshold number of activations and the cost of the alternative service is less than a predetermined threshold cost. The consumer may further define such a potential action preference to instruct optimizing device 106 to notify the consumer when the service is automatically changed to the alternative service or to instruct optimizing device 106 to request permission to change the service to the alternative service when the number of activations of the current service exceeds the threshold number of activations but the cost of the alternative service is greater than the predetermined threshold cost.

In certain configurations, action preference-receiving device 108 may receive information about, for example, one or more of types of services being activated for the consumer, a number of each type of service activated for the consumer, a timing of service activations for the consumer, information about SLAs associated with the consumer's services comprising defined quality attributes, actual quality attributes of services provided to the consumer, and other use patterns of the consumer, as well as similar information related to other consumers. Such information may be information acquired by, for example, monitoring device 116 (described below). Action preference-receiving device 108 may analyze such information and use results of the analysis to generate potential action preferences for the consumer, without soliciting or receiving an optimization policy or a list of potential action preferences from the consumer. Accordingly, action preference-receiving device 108 proactively may determine the potential action preferences of the consumer, which may save the consumer from the time commitment and frustration of defining potential action preferences or an optimization policy. In some configurations, action preference-receiving device 108 may receive one or more potential action preferences from the consumer in addition to the above-described information, and action preference-receiving device 108 may use the above-described information to modify the one or more potential action preferences, such that the one or more potential action preferences evolve in accordance with changes to the consumer's consumption of the service.

In S109, one or more of the service provider and the other party may monitor the service provided to the consumer. In particular, the one or more of the service provider and the other party may monitor, for example, a history of actions activated by the consumer (e.g., what actions were activated; when the actions were activated; a length of time that the actions were activated, comprising a behavioral profile of use during that length of time; where the actions were activated, such as a geographical region of activation or local activations; in what language the activations occurred; how frequently activations occurred), a level of service quality (e.g., actual quality attributes of the service) experienced by the consumer or experienced by particular individuals within the consumer (e.g., individual employees and devices or groups of employees and devices using the service under a consumer's account), and recent performance of the service (e.g., whether the quality has improved or degraded since the consumer last used the service). The one or more of the service provider and the other party also may monitor such information for other users or consumers of the service provided to the consumer and may create statistical datasets therefrom. Moreover, the one or more of the service provider and the other party may monitor the service for available changes to the service provided to the consumer (e.g., alternative services), such as, for example, upgrades, discounted costs, increasing quality of the service (e.g., more value at the same cost), same quality service with reduced cost (e.g., more value for less cost), and other improvements that may benefit the consumer. The one or more of the service provider and the other party may monitor the service using monitoring device 116.

In certain configurations, monitoring device 116 may monitor alternative services available to the consumer and provided by one or more different service providers as well as the current service provider. Such alternative services may be offered by other service providers and may have, for example, one or more cost attributes, availability attributes, and other quality attributes that may be different from the actual quality attributes of the current service provided to the consumer. By monitoring such alternative services, monitoring device 116 may collect quality attributes of the alternative services and may create additional statistical datasets therefrom.

In certain modified configurations, system 100 may utilize information acquired through monitoring device 116 to establish potential action preferences for the consumer in addition to or in the alternative of the optimization policy provided by the consumer. For example, system 100 may utilize the history of actions activated by particular users within the consumer to establish a potential action preference for the consumer (e.g., all or a sizeable subset of individuals within the consumer) to activate one or more of the actions which historically has been activated often. In similar configurations, system 100 may utilize, for example, the historical actions of other consumers with similar backgrounds to the consumer in order to establish potential action preferences for the consumer. In such configurations, action-preference-receiving device 108 and S107 may be omitted or modified, as appropriate.

In S111, the one or more of the service provider and the other party may compare one or more of the actual quality attributes of the service provided to the consumer with one or more potential quality attributes of alternative services that may be achieved by implementing one or more of the available changes to the service provided to the consumer. In some configurations, the potential quality attributes, for example, may be determined from statistical data sets derived from monitoring the quality attributes of services provided to other consumers that have implemented the one or more of the available changes. In certain configurations, the potential quality attributes, for example, may be determined from calculations based on the predicted impact of the one or more of the available changes and historical activation of related actions by the consumer or other consumers. In such configurations, the one or more of the service provider and the other party may determine the potential quality attributes using comparing device 118 with information from monitoring device 116 and other data sources. In other configurations, the potential quality attributes of the service may be determined from the quality attributes defined for the service in the SLA. For example, when the SLA defines a requirement that the service is provided with a 95% availability, a potential quality attribute may be that the service has a 95% availability. Further, comparing device 118 may perform the comparison between actual quality attributes of the service and potential quality attributes of alternative services.

In certain configurations, comparing device 118 may compare one or more potential quality attributes of one or more alternative services with one or more corresponding actual quality attribute of the service provided to the consumer in S111. In such configurations, comparing device 118 may determine a difference between the one or more potential quality attributes and the one or more corresponding actual quality attributes (e.g., an availability of an alternative service is 5% greater than an availability of the service provided to the consumer, a monthly cost of storage space for an alternative service is three dollars ($3) less per terabyte than the monthly cost of the service provided to the consumer).

In S113, optimizing device 106 may use the results of the comparison in S111 to determine whether one or more specific criterion defined in the potential action preferences for the consumer is satisfied. For example, when the potential action preference comprise a specific criterion that an actual quality attribute of the service is less than a potential quality attribute of the service by at least a 5% difference, optimizing device 106 may determine that the specific criterion is satisfied when an actual availability of the service is an 85% availability and the potential availability of the service is a 95% availability. Accordingly, the process may proceed to S115 when the specific criterion is satisfied (S113: YES). When the specific criterion is not satisfied (e.g., when the actual availability of the service is, for example, a 96% availability in the above-described example) (S113: NO), the process may proceed to S117.

In another example configuration, when the potential action preference comprise a specific criterion that an actual quality attribute of the current service is less than a quality attribute of an alternative service by at least a 5% difference, optimizing device 106 may determine that the specific criterion is satisfied when an actual availability of the current service is an 85% availability and the availability of the alternative service is a 95% availability. Accordingly, the process may proceed to S115 when the specific criterion is satisfied (S113: YES). When the specific criterion is not satisfied (e.g., when the actual availability of the service is, for example, a 96% availability in the above-described example) (S113: NO), the process may proceed to S117.

In certain configurations, comparing device 118 may compare the difference between the one or more potential quality attributes and the one or more corresponding actual quality attributes with one or more potential action preference of the consumer in S113. In an example configuration, comparing device 118 may determine in S111 that the difference between the one or more potential quality attributes and the one or more corresponding actual quality attributes is, for example, that an availability of an alternative service is 5% greater than an availability of the service provided to the consumer. Continuing with the example, in S113, comparing device 118 may compare the difference of 5% greater availability with a specific criterion defined in the potential action preferences. The specific criterion may be, for example, a criterion that the difference between a potential quality attribute of an alternative service and a corresponding actual quality attribute of the service provided to the consumer is greater than 1%. Accordingly, in this example, comparing device 118 may determine that the specific criterion is satisfied (S113: YES), and the process may proceed to S115.

In S15, action-performing device 120 may perform an action defined in the potential action preferences that corresponds to the specific criterion that was determined to be satisfied in S113. For example, the potential action preference may be that the availability of the service is to be automatically increased by at least a 5% availability (e.g., an action according to the potential action preference) when the current, actual availability of the service is less than a potential availability of the service by at least an availability of 5% (e.g., a specific criterion according to the potential action preference). In the above-described example, when the specific criterion is determined to be satisfied (S113: YES), action-performing device 120 automatically may increase the availability of the service by at least an availability of 5%.

In another example, the potential action preference may be that the availability of the service is to be automatically increased by at least a 5% availability (e.g., an action according to the potential action preference) when the actual availability of the current service provided to the consumer is less than a potential availability of the service by at least an availability of 5% (e.g., a specific criterion according to the potential action preference). In the above-described example, when the specific criterion is determined to be satisfied (S113: YES), action-performing device 120 automatically may switch to an alternative service with an availability that is greater than the actual availability of the service by at least an availability of 5%.

In certain configurations, the potential action preferences may comprise broad or general instructions for actions to be performed when a specific criterion is satisfied. Consequently, in such configurations, the actions may be performed in many different manners. For example, automatically increasing the availability of the service by at least an availability of 5% may be accomplished by, for example, one or more of setting a new maintenance schedule for the service that results in less down time than an old maintenance schedule, upgrading the infrastructure for providing the service (e.g., replacing network devices, updating network applications), and initiating additional proactive monitoring for failures of the service. Thus, action-performing device 120 may use information, which was acquired by monitoring device 116, regarding available changes to the service to determine available actions that may, alone or in combination, satisfy the requirements of the potential action preferences. For example, referring to the above-described example, more than one service change may be required to increase the availability of the service by at least an availability of 5%. Thus, action performing device 120 may implement more than one change to satisfy the potential action requirements. In addition, the actions performed by action-performing device 120 may comprise changing the service by implementing one or more of the available changes monitored by monitoring device 116 in S109.

In addition, action-performing device 120 may utilize the potential action preferences defined in defining device 112 to optimize the changes, such that the changes made to the service provide the consumer with a preferred level of quality (e.g., a balanced combination of appropriate cost and functional services that meet or exceed the demands of the consumer).

When the consumer provides appropriate preferences to action preference-receiving device, action-performing device 120 may find combinations of changes appropriate to the consumer's needs and desires.

In some configurations, action-performing device 120 may utilize the potential action preferences defined in defining device 112 to select an optimized alternative service, such that the alternative service selected provides the consumer with a preferred level of quality (e.g., a balanced combination of appropriate cost and functional services that meet or exceed the demands of the consumer). When the consumer provides appropriate preferences to action preference-receiving device 120, action-performing device 120 may find an available alternative service appropriate to the consumer's needs and desires. In certain configurations, action-performing device 120 may select an alternative service to provide to the consumer from a set of alternative services monitored by monitoring device 116 in S109.

The potential action preferences may comprise notification preferences. Such notification preferences may be specified by the consumer. Alternatively or additionally, the notification preferences may be specified by the one or more of the service provider and the other party. The notification preferences may comprise, for example, one or more of an instruction to notify the consumer of actions (e.g., changes to the service) that have been automatically performed and an instruction to notify the consumer of particular, available actions and to request that the consumer selects which actions are to be performed. Action-performing device 120 may perform the notification according to the notification preferences. Accordingly, in certain configurations, action-performing device 120 may notify the consumer of changes to the service after the changes have been made, such that the consumer may be made aware of the changes and is able to observe the benefits of optimizing device 106. Moreover, in other configurations, action-performing device 120 may present one or more available changes to the consumer before activating the changes, such that the consumer may have the option to select which changes finally are activated and which subsequent actions are to be performed. In certain configurations, action-performing device 120 may notify the consumer when a specific criterion defined in the potential action preferences has been satisfied.

In certain configurations, the consumer may comprise an organization or group of individuals. In such configurations, the consumer may specify certain potential action preferences (e.g., global potential action preferences) for services provided to the individuals. Further, a particular individual may specify particular potential action preferences (e.g., particular individual potential action preferences) for services provided to the particular individual. Other individuals of the consumer may specify other potential action preferences (e.g., other individual potential action preferences). The certain potential action preferences specified by the consumer may limit or restrict the particular action preferences that may be specified by the particular individual and the other potential action preferences specified by the other individuals. In such configurations, action-performing device 120 may change or replace the service being provided to the particular individual in a different manner than action-performing device 120 may change or replace the service being provided to the other individuals, based on differences between the particular potential action preferences and the other potential action preferences. Nevertheless, each of the different manners of changing or replacing the service being provided may satisfy the certain potential action preferences specified by the consumer.

For example, the consumer may specify a certain potential action preference that limits the cost of increasing availability to five dollars ($5). The particular individual may specify a particular potential action preference for increasing availability until the cost exceeds three dollars ($3). The other individuals may specify another potential action preference for increasing availability regardless of cost. In such an example, an available change to the service may increase the availability of the service by 5% for every one dollar ($1) increase in cost. Consequently, action-performing device 120 may change the service provided to the particular individual, such that the availability of the service is increased by 15% for a total cost of three dollars ($3), and action-performing device may change the service provided to the other individuals, such that the availability of the service is increased by 25% for a total cost of five dollars ($5), in accordance with the certain potential action preferences, the particular potential action preferences, and the other potential action preferences.

After action-performing device 120 performs one or more action according to one or more potential action preference in S115, the process moves to S117. In S117, optimizing device 106 determines whether the service has expired (e.g., the term of the service in the SLA has ended, a triggering event specified in the SLA has occurred and the service has ended, the consumer has terminated the service). If the service has not expired (S117: NO), the process returns to S109. If the service has expired (S117: YES), the process moves to S119.

In S119, optimizing device 106 offers one or more new service (e.g., an alternate service, the now-expired service, the now-expired service with changes) to the consumer. Optimizing device 106 may select the one or more new service to offer the consumer based on one or more of the potential action preferences of the consumer and the SLA for the now-expired service. In some configurations, the offer may comprise a new SLA or a renewal of the old SLA. In certain configurations, optimizing device 106 may notify the consumer of the offer of the one or more new service and may request that the consumer select and agree to the one or more new service. In such configurations, the process may move to S121.

In S121, optimizing device 106 may determine whether the consumer has accepted the offer for the new service. If the consumer accepts the offer for the new service (S121: YES), the process may return to S109. If the consumer does not accept the new service (S121: NO), the process may end.

In other configurations, when the potential action preferences indicate a preference for automatic renewal of a service, optimizing device 106 automatically may select a new service for the consumer in accordance with the one or more of the potential action preferences of the consumer and the SLA for the now-expired service, and optimizing device 106 automatically may activate the new service for the consumer. In such configurations, S121 is omitted and the process may return to S109. Depending on the notification preferences, optimizing device 106 may notify the consumer of the activation of the new service and may provide information about the new service to the consumer. In such configuration, the optimization process may end when the consumer terminates the service.

The flowcharts and block diagrams in FIGS. 1-3 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

1. A method comprising:
monitoring a plurality of services provided to a plurality of consumers;
determining an actual quality attribute of a particular service of the plurality of services provided to a particular consumer of the plurality of consumers based on at least one monitored parameter of the particular service;
determining a potential action preference for the particular consumer based on a history of activation of each of the plurality of services by other consumers of the plurality of consumers that previously activated the particular service;
determining a potential quality attribute of an alternative service of the plurality of services based on statistical data sets including particular data for each consumer of the plurality of consumers that has implemented a change from the particular service to the alternative service, the particular data for each such consumer derived from the at least one monitored parameter of the alternative service provided to such consumer;
comparing the potential quality attribute of the alternative service with the actual quality attribute of the particular service provided to the particular consumer to determine a difference between the potential quality attribute and the actual quality attribute;
analyzing, by one or more processors, the difference between the potential quality attribute and the actual quality attribute utilizing the potential action preference for the particular consumer; and
performing an action according to the potential action preference in response to determining that the difference between the potential quality attribute and the actual quality attribute satisfies a specific criterion defined in the potential action preference.

2. The method of claim 1,
wherein the alternative service is a modified instance of the particular service provided to the particular consumer, and
wherein both the particular service provided to the particular consumer and the alternative service are provided by a same service provider.

3. The method of claim 1, wherein the potential action preference comprises:
an instruction to perform the action, which comprises notifying the particular consumer that the specific criterion is satisfied, in response to determining that the specific criterion is satisfied,
wherein the specific criterion comprises a criterion that the potential quality attribute of the alternative service has a greater quality value than the actual quality attribute of the particular service provided to the particular consumer.

4. The method of claim 3, wherein the potential action preference further comprises:
an instruction to perform the action, which comprises making an offer offering the alternative service to the particular consumer, in response to determining that the specific criterion is satisfied; and
an instruction to perform the action, which comprises updating the particular service provided to the particular consumer to the alternative service, in response to determining that the particular consumer accepts the offer.

5. The method of claim 1, wherein the potential action preference comprises:
an instruction to perform the action, which comprises updating automatically the particular service provided to the particular consumer to the alternative service, in response to determining that the specific criterion is satisfied,
wherein the specific criterion comprises a criterion that the potential quality attribute of the alternative service has a greater quality value than the actual quality attribute of the particular service provided to the particular consumer.

6. The method of claim 5, wherein the potential action preference further comprises:
an instruction to perform the action, which comprises notifying the particular consumer that the particular service provided to the particular consumer was changed automatically to the alternative service, in response to determining that the specific criterion is satisfied.

7. The method of claim 1, wherein the actual quality attribute of the particular service provided to the particular consumer and the potential quality attribute of the alternative service each comprise:
a metric corresponding to an availability of the service;
a metric corresponding to a cost of the service;
a metric corresponding to a risk associated with the service; and
a metric associated with recovery options available with the service.

8. (canceled)

9. A system comprising:
a monitoring device configured to monitor a plurality of services provided to a plurality of consumers, the monitoring device further configured to determine an actual quality attribute of a particular service provided to a particular consumer of the plurality of consumers based on at least one monitored parameter of the particular service;
an action preference-receiving device configured to determine a potential action preference for the particular consumer based on a history of activation of each of the plurality of services by other consumers of the plurality of consumers that previously activated the particular service;
a comparing device configured to determine a potential quality attribute of an alternative service of the plurality of services based on statistical data sets including particular data for each consumer of the plurality of consumers that has implemented a change from the particular service to the alternative service, the particular data for each such consumer derived from the at least one monitored parameter of the alternative service provided to such consumer,
wherein the comparing device is further configured to compare the potential quality attribute of the alternative service with the actual quality attribute of the particular service provided to the particular consumer to determine a difference between the potential quality attribute and the actual quality attribute, and
wherein the comparing device is further configured to analyze the difference between the potential quality attribute and the actual quality attribute utilizing the potential action preference for the particular consumer, and
an action-performing device configured to perform an action according to the potential action preference in response to determining that the difference between the potential quality attribute and the actual quality attribute satisfies a specific criterion defined in the potential action preference.

10. The system of claim 9, wherein the potential action preference comprises:
an instruction for the action-performing device to perform the action, which comprises notifying the particular consumer that the specific criterion is satisfied, in response to determining that the specific criterion is satisfied,
wherein the specific criterion comprises a criterion that the potential quality attribute of the alternative service has a greater quality value than the actual quality attribute of the particular service provided to the particular consumer.

11. The system of claim 10, wherein the potential action preference further comprises:
an instruction for the action-performing device to perform the action, which comprises making an offer offering the alternative service to the particular consumer, in response to determining that the specific criterion is satisfied; and
an instruction for the action-performing device to perform the action, which comprises updating the particular service provided to the particular consumer to the alternative service, in response to determining that the particular consumer accepts the offer.

12. The system of claim 9, wherein the potential action preference comprises:
an instruction for the action-performing device to perform the action, which comprises updating automatically the particular service provided to the particular consumer to the alternative service, in response to determining that the specific criterion is satisfied,
wherein the specific criterion comprises a criterion that the potential quality attribute of the alternative service has a greater quality value than the actual quality attribute of the particular service provided to the particular consumer.

13. The system of claim 12, wherein the potential action preference further comprises:
an instruction for the action-performing device to perform the action, which comprises notifying the particular consumer that the particular service provided to the consumer was changed automatically to the alternative service, in response to determining that the specific criterion is satisfied.

14. (canceled)

15. A computer program product comprising:
a computer readable storage medium having computer readable program code embodied therewith, the computer readable program code comprising:
computer readable program code configured to monitor a plurality of services provided to a plurality of consumers;
computer readable program code configured to determine an actual quality attribute of a particular service provided to a particular consumer of the plurality of consumers based on at least one monitored parameter of the particular service;
computer readable program code configured to determine a potential action preference for the particular consumer based on a history of activation of each of the plurality of services by other consumers of the plurality of consumers that previously activated the particular service;
computer readable program code configured to determine a potential quality attribute of an alternative service of the plurality of services based on statistical data sets including particular data for each consumer of the plurality of consumers that has implemented a change from the particular service to the alternative service, the particular data for each such consumer derived from the at least one monitored parameter of the alternative service provided to such consumer;
computer readable program code configured to compare the potential quality attribute of the alternative service with the actual quality attribute of the particular service provided to the particular consumer to determine a difference between the potential quality attribute and the actual quality attribute;
computer readable program code configured to analyze the difference between the potential quality attribute and the actual quality attribute utilizing the potential action preference for the particular consumer, and
computer readable program code configured to perform an action according to the potential action preference in response to determining that the difference between the potential quality attribute and the actual quality attribute satisfies a specific criterion defined in the potential action preference.

16. The computer program product according to claim 15, wherein the potential action preference comprises:
computer readable program code configured to perform the action, which comprises notifying the particular consumer that the specific criterion is satisfied, in response to determining that the specific criterion is satisfied,
wherein the specific criterion comprises a criterion that the potential quality attribute of the alternative service has a greater quality value than the actual quality attribute of the particular service provided to the particular consumer.

17. The computer program product according to claim 16, wherein the potential action preference comprises:
computer readable program code configured to perform the action, which comprises making an offer offering the alternative service to the particular consumer, in response to determining that the specific criterion is satisfied; and
computer readable program code configured to perform the action, which comprises updating the particular service provided to the particular consumer to the alternative service, in response to determining that the particular consumer accepts the offer.

18. The computer program product according to claim 15, wherein the potential action preference comprises:
computer readable program code configured to perform the action, which comprises updating automatically the particular service provided to the particular consumer to the alternative service, in response to determining that the specific criterion is satisfied,
wherein the specific criterion comprises a criterion that the potential quality attribute of the alternative service has a greater quality value than the actual quality attribute of the particular service provided to the particular consumer.

19. The computer program product according to claim 18, wherein the potential action preference comprises:
computer readable program code configured to perform the action, which comprises notifying the particular consumer that the particular service provided to the particular consumer was changed automatically to the alternative service, in response to determining that the specific criterion is satisfied.

20. (canceled)

21. The method of claim 1, wherein the potential action preference for the particular consumer is further based on a restriction imposed by a provider of at least one service of the plurality of services.

22. The method of claim 1,
wherein determining the potential action preference for the particular consumer comprises:
determining a global potential action preference based on the history of activation of each of the plurality of services by the other consumers; and
determining a particular consumer potential action preference based on preference data received from the particular consumer, and
wherein the action performed according to the potential action preference comprises an action permitted by both the global potential action preference and the particular consumer potential action preference.

23. The method of claim 22,
wherein the global potential action preference indicates a first maximum allowable cost to utilize the alternative service,
wherein the particular consumer potential action preference indicates a second maximum allowable cost to utilize the alternative service,
wherein the specific criterion defined in the potential action preference is that a particular cost to utilize the alternative service is less than or equal to both the first maximum allowable cost and the second maximum allowable cost, and
wherein the action performed according to the potential action preference comprises changing the service provided to the particular consumer from the particular service to the alternative service.
